(19) United States
(12) Patent Application Publication
(10) Pub. No.: US 2025/0218212 A1
(43) Pub. Date: Jul. 3, 2025

(54) FINGERPRINT SENSOR WITH CHARGE MODIFICATION ARRANGEMENT

(71) Applicant: FINGERPRINT CARDS ANACATUM IP AB, GÖTEBORG (SE)

(72) Inventors: Frank RIEDIJK, DELFT (NL); Wouter BREVET, DELFT (NL)

(21) Appl. No.: 18/851,297

(22) PCT Filed: Apr. 4, 2023
(86) PCT No.: PCT/SE2023/050305

§ 371 Date: Sep. 26, 2024

(30) Foreign Application Priority Data
Apr. 8, 2022 (SE) 2250444-3

(51) Int. Cl. G06V 40/13

(52) U.S. Cl. CPC G06V 40/1306

(57) ABSTRACT

A fingerprint sensor comprising: a plurality of sensing structures arranged in a sensing plane for capacitively sensing a fingerprint; a charge-modification arrangement including: a plurality of charge-modification structures arranged in relation to the plurality of sensing structures to form a plurality of capacitors; and charge-modification circuitry coupled to each charge-modification structure in the plurality of charge-modification structures, and controllable to provide voltage signals to the plurality of charge-modification structures, to thereby modify amounts of charge carried by the sensing structures; and measurement circuitry coupled to the plurality of sensing structures for providing measurement signals indicative of a capacitive coupling between each sensing structure in the plurality of sensing structures and the finger, wherein the charge-modification arrangement is configured to provide different charge modification for different sensing structures in the plurality of sensing structures.

### FIELD OF THE INVENTION

The present invention relates to a fingerprint sensor, to an electronic device comprising the fingerprint sensor, and to a method of acquiring a fingerprint representation.

### BACKGROUND OF THE INVENTION

Biometric systems are widely used as means for increasing the convenience and security of personal electronic devices, such as mobile phones etc. Fingerprint sensing systems, in particular, are now included in a large proportion of all newly released personal communication devices, such as mobile phones.

Many electronic devices have various curved surfaces for providing an improved user experience. It would be desirable to provide for improved integration of fingerprint sensing capability in such electronic devices.

### SUMMARY

In view of the above, it is an object of the present invention to provide for improved integration of fingerprint sensing capability in an electronic device having at least one curved surface portion.

According to a first aspect of the present invention, it is therefore provided a fingerprint sensor comprising: a plurality of sensing structures arranged in a sensing plane for capacitively sensing a fingerprint of a finger placed on a finger receiving surface of the fingerprint sensor; a charge-modification arrangement including: a plurality of charge-modification structures arranged in relation to the plurality of sensing structures to form a plurality of capacitors, each including a sensing structure in the plurality of sensing structures, a charge-modification structure in the plurality of charge-modification structures, and a dielectric between the sensing structure and the charge-modification structure; and charge-modification circuitry coupled to each charge-modification structure in the plurality of charge-modification structures, and controllable to provide voltage signals to the plurality of charge-modification structures, to thereby modify amounts of charge carried by the sensing structures; and measurement circuitry coupled to the plurality of sensing structures for providing measurement signals indicative of a capacitive coupling between each sensing structure in the plurality of sensing structures and the finger, wherein the charge-modification arrangement is configured to provide different charge modification for different sensing structures in the plurality of sensing structures.

The present invention is based on the general realization that it would be beneficial to enable a non-flat topography of a finger receiving surface, in an electronic device using a capacitive fingerprint sensor in which the sensing structures are arranged in a sensing plane. The present inventors have further realized that the sensing performance of a fingerprint sensor in such a configuration can be improved by adding or subtracting different amounts of charge from sensing structures arranged to be covered by different thicknesses of dielectric material.

Hereby, a more uniform signal strength baseline can be achieved across the sensing plane, which in turn provides for improved fingerprint image quality. The thus improved fingerprint image quality can be translated to improved biometric authentication performance of the electronic device in which the fingerprint sensor according to embodiments of the present invention is integrated. Furthermore, according to embodiments of the present invention, the compensation for the different thicknesses of dielectric material can be made at the beginning of the measurement chain, which may be beneficial for the measurement performance of the fingerprint sensor, for example in terms of the signal-to-noise ratio, also providing for improved fingerprint image quality.

The charge-modification arrangement may advantageously be configured to provide charge modification that is adapted to, or adaptable to, different configurations of the finger receiving surface.

For a convex finger receiving surface, the thickness of dielectric material covering the sensing structures will be greater for centrally located sensing structures than for peripheral sensing structures. For such a configuration, the charge-modification arrangement may be configured to subtract more charge from the peripheral sensing structures than from the centrally located sensing structures. Alternatively, the charge-modification arrangement may be configured to add a first amount of charge to a peripherally located sensing structure, and to add a second amount of charge, greater than the first amount of charge, to a centrally located sensing structure. According to another alternative, the charge-modification arrangement may be configured to subtract charge from a peripherally located sensing structure, and to add charge to a centrally located sensing structure.

For a concave finger receiving surface, the charge modification should be opposite the situation described above for a convex finger receiving surface.

The different charge modifications for different sensing structures may be achieved through various configurations of the charge-modification arrangement. Different sensing structures may exhibit different capacitive coupling to the charge-modification structure(s) and/or the charge-modification circuitry may be configured to provide different voltage signals to charge-modification structures that are capacitively coupled to different sensing structures.

The fingerprint sensor according to embodiments of the present invention may comprise dielectric material covering the sensing plane of the fingerprint sensor, the dielectric material having a non-uniform thickness profile defining a topography of the finger receiving surface of the fingerprint sensor.

The dielectric material could, for example, be provided in the form of a suitably shaped window against which a planar surface of a fingerprint sensor according to embodiments of the present invention is pressed or glued. Alternatively, or in combination, the dielectric material may be molded on the sensing surface of the fingerprint sensor, whereby it can practically be ensured that there is no air gap between the sensing plane and the finger receiving surface.

According to a second aspect of the present invention, it is provided a method of acquiring a fingerprint representation using a fingerprint sensor with a finger receiving surface to be touched by a finger, the fingerprint sensor comprising a plurality of sensing structures arranged in a sensing plane; a charge-modification arrangement including a plurality of charge-modification structures arranged in relation to the plurality of sensing structures to form a plurality of capacitors, each including a sensing structure in the plurality of sensing structures, a charge-modification structure in the plurality of charge-modification structures, and a dielectric between the sensing structure and the charge-modification structure; and charge-modification circuitry coupled to each charge-modification structure in the plurality of charge-modification structures, and controllable to provide voltage signals to the plurality of charge-modification structures, to thereby modify amounts of charge carried by the sensing structures; and measurement circuitry coupled to the plurality of sensing structures for providing measurement signals indicative of a capacitive coupling between each sensing structure in the plurality of sensing structures and the finger; and dielectric material covering the sensing plane, the dielectric material having a non-uniform thickness profile defining a topography of the finger receiving surface of the fingerprint sensor,
the method comprising the steps of: acquiring a first set of measurement signals from a first set of sensing structures in the plurality of sensing structures, covered by a thickness of the dielectric material within a first thickness range, while providing by the charge-modification arrangement a first charge modification to the first set of sensing structures; and acquiring a second set of measurement signals from a second set of sensing structures in the plurality of sensing structures, covered by a thickness of the dielectric material within a second thickness range, only including greater thicknesses than the first thickness range, while providing by the charge-modification arrangement a second charge modification to the second set of sensing structures.

In summary, embodiments of the present invention thus relate to a fingerprint sensor comprising: a plurality of sensing structures arranged in a sensing plane for capacitively sensing a fingerprint; a charge-modification arrangement including: a plurality of charge-modification structures arranged in relation to the plurality of sensing structures to form a plurality of capacitors; and charge-modification circuitry coupled to each charge-modification structure in the plurality of charge-modification structures, and controllable to provide voltage signals to the plurality of charge-modification structures, to thereby modify amounts of charge carried by the sensing structures; and measurement circuitry coupled to the plurality of sensing structures for providing measurement signals indicative of a capacitive coupling between each sensing structure in the plurality of sensing structures and the finger, wherein the charge-modification arrangement is configured to provide different charge modification for different sensing structures in the plurality of sensing structures.

### BRIEF DESCRIPTION OF THE DRAWINGS

These and other aspects of the present invention will now be described in more detail, with reference to the appended drawings showing an example embodiment of the invention, wherein:

FIG. 1 is an illustration of an exemplary electronic device comprising a fingerprint sensor according to an embodiment of the present invention, in the form of a mobile phone;

FIG. 2 is an enlarged view of a portion of the electronic device in FIG. 1;

FIGS. 3A-B are perspective views of the fingerprint sensor comprised in the mobile phone in FIG. 1 and FIG. 2;

FIG. 4 is a partly opened perspective schematic illustration of the fingerprint sensor comprised in the mobile phone in FIG. 1 and FIG. 2;

FIG. 5 is a schematic cross-section view of the fingerprint sensor in FIG. 4;

FIG. 6 schematically illustrates an example embodiment of the fingerprint sensor according to the present invention;

FIG. 7 schematically shows a first example configuration of the measurement circuitry and charge-modification arrangement in the fingerprint sensor in FIG. 6;

FIGS. 8A-D schematically illustrate different configurations of the charge-modification arrangement in the fingerprint sensor in FIG. 6; and

FIGS. 9A-C schematically illustrate additional configurations of the charge-modification arrangement in the fingerprint sensor in FIG. 6.

### DETAILED DESCRIPTION OF EXAMPLE EMBODIMENTS

In the present detailed description, various embodiments of the fingerprint sensor according to the present invention are mainly described with reference to a fingerprint sensor component including a semiconductor-based capacitive fingerprint sensor integrated circuit (IC). It should be noted that the fingerprint sensor according to embodiments of the present invention need not be overmolded by dielectric material, and that the topography of the finger receiving surface could alternatively be achieved using a separate part attached to or suitably arranged in relation to the fingerprint sensor. Furthermore, the finger receiving surface of the fingerprint sensor is mainly exemplified as a convex surface. It should be noted that the present invention, as defined by the claims, is not limited to any particular shape or configuration of the finger receiving surface. Moreover, the fingerprint sensor does not have to be elongated, but could be any other shape, such as square or round, etc. Furthermore, it should be understood that the mobile phone in the figures is only one example of an electronic device that may comprise the fingerprint sensor according to embodiments of the present invention. The fingerprint sensor according to embodiments of the present invention may advantageously be included in many other electronic devices, including, for example, computers, electronic watches and other gadgets, as well as smart cards, etc.

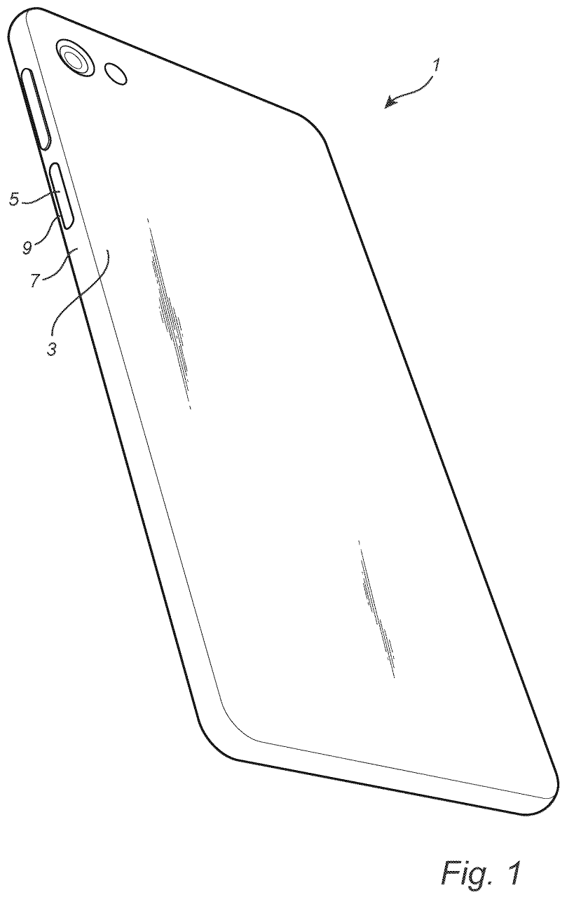

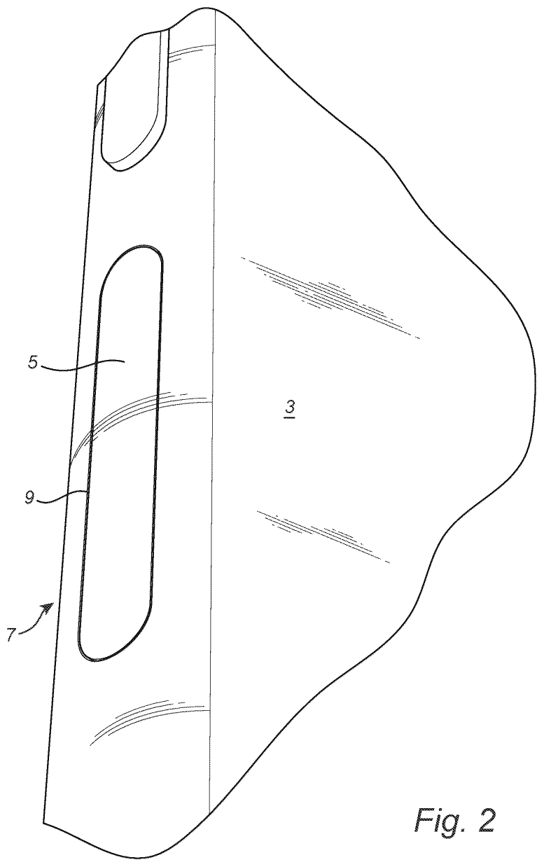

FIG. 1 schematically shows an electronic device, here in the form of a mobile phone 1, comprising a device housing 3 and a fingerprint sensor 5. As can be seen in FIG. 1, the device housing 3 has a convex portion 7 with an opening 9. The fingerprint sensor 5 is arranged in the opening 9 and also exhibits a convex shape. The convex shape of the fingerprint sensor 5 may substantially follow the convex shape of the convex portion 7 of the device housing 3, at least at the opening 9. This is better seen in the partial enlargement in FIG. 2.

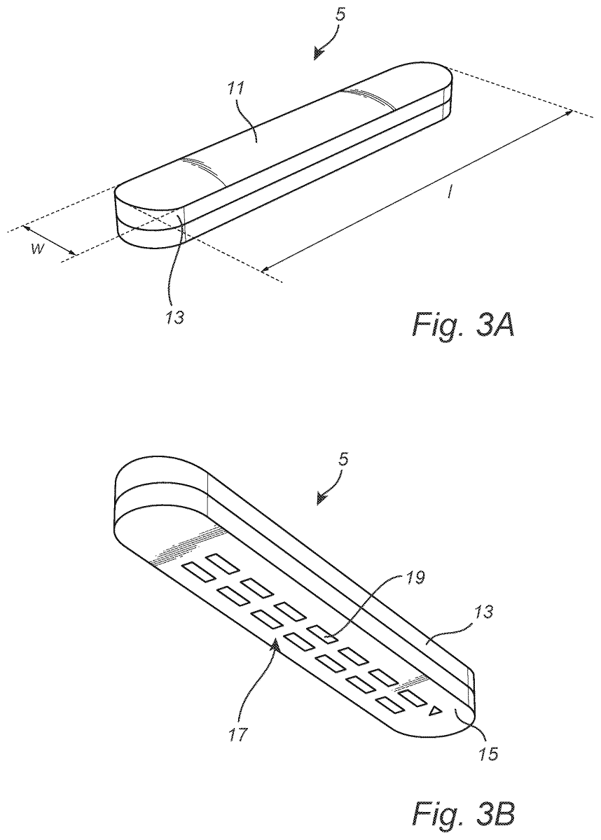

FIGS. 3A-B are perspective views of the fingerprint sensor 5 comprised in the mobile phone 1 in FIG. 1 and FIG. 2.

FIG. 3A is a perspective view showing a component top face 11 and a side surface 13 of the fingerprint sensor 5. As can be seen in FIG. 3A, the fingerprint sensor 5 in this particular example configuration is elongated having a length l and a width w.

FIG. 3B is a perspective view showing a component bottom face 15 and the side surface 13 of the fingerprint sensor 5. As can be seen in FIG. 3B, the fingerprint sensor 5 has a component conductor pattern 17 on the component bottom face 15. In the embodiment of FIG. 3B, the component conductor pattern 17 defines a land grid array with a plurality of component connection pads 19 (only one of these is indicated by a reference numeral in FIG. 3B to avoid cluttering the drawing).

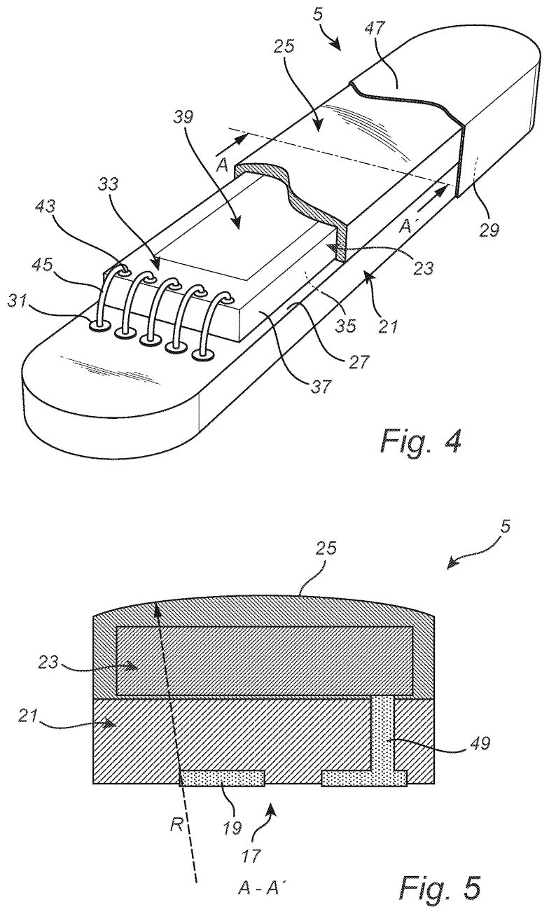

FIG. 4 is a partly opened perspective schematic illustration of the fingerprint sensor 5 comprised in the mobile phone 1 in FIG. 1, and shown in FIG. 3A and FIG. 3B. Referring to FIG. 4, the fingerprint sensor 5 comprises a substrate 21, a fingerprint sensor die 23, and a dielectric material 25. The substrate 21 has a substrate top face 27 and a substrate bottom face 29. The substrate top face 27 has a top face conductor pattern, including the bond pads 31 visible in FIG. 4, and (although not visible in FIG. 4) the substrate bottom face 29 has a bottom face conductor pattern, which may constitute the component conductor pattern 17 described above with reference to FIG. 3B. The fingerprint sensor die 23 has a die top face 33, a die bottom face 35, and a side surface 37 connecting the die top face 33 and the die bottom face 35. The die top face 33 includes a planar sensing surface 39. The die bottom face 35 of the fingerprint sensor die 23 is bonded to the substrate top face 27 of the substrate 21. As is schematically indicated in FIG. 4, the fingerprint sensor die 23 further comprises die connection pads 43, which are electrically connected to the bond pads 31 on the substrate top face 27 of the substrate 21. This electrical connection may be achieved using bond wires 45 as indicated in FIG. 4, or by any other suitable connector known to the skilled person. The dielectric material 25 covers the sensing surface 39 and the side surface 37 of the fingerprint sensor die 23, as well as a portion of the substrate top face 27 of the substrate 21 that is not covered by the fingerprint sensor die 23. As is schematically indicated in FIG. 4, the dielectric material 25 exhibits a convex shape over the sensing surface 39 of the fingerprint sensor die 23. As is schematically indicated in FIG. 4, the fingerprint sensor 5 may optionally additionally include a colored coating 47 on top of the dielectric material 25.

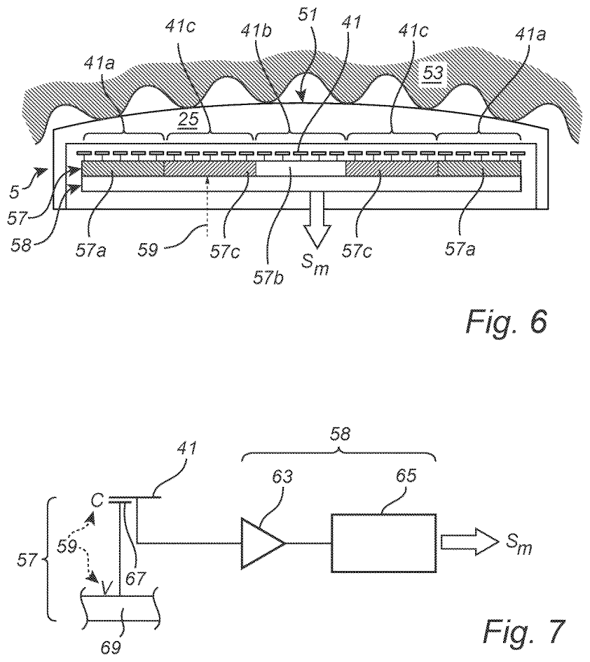

FIG. 5 is a schematic cross-section view of the fingerprint sensor 5 in FIG. 4, of a section taken along the line A-A′ in FIG. 4. In addition to what has already been described above with reference to FIG. 4, FIG. 5 schematically shows a via 49 electrically connecting the top face conductor pattern of the substrate 21 with the bottom face conductor pattern 17 of the substrate 21. FIG. 5 also indicates an advantageous configuration of the convex shape of the dielectric material 25. As is indicated in FIG. 5, the top surface (the finger receiving surface) of the fingerprint sensor 5 exhibits a convex shape with a radius R of curvature. The radius R of curvature of the fingerprint sensor 5 may be adapted to substantially follow a radius of curvature of the convex portion 7 of the device housing 3 of the electronic device 1.

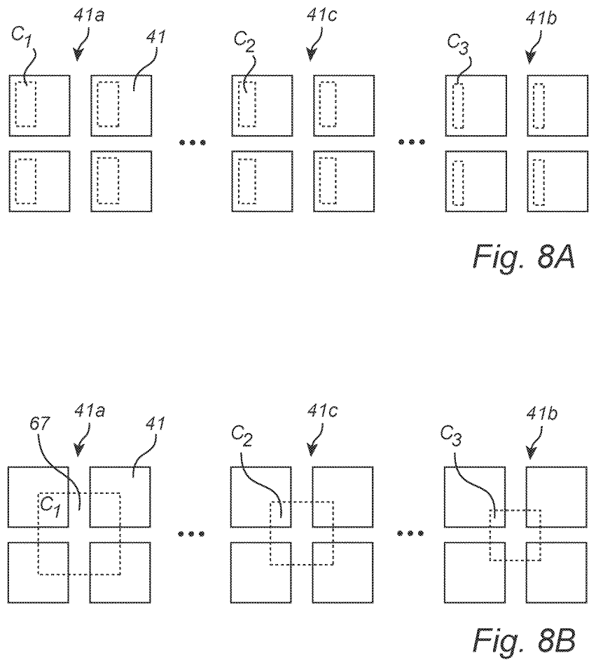

FIG. 6 is a schematic cross-section view of a fingerprint sensor 5 according to an example embodiment of the present invention, comprising dielectric material 25 having a non-uniform thickness profile defining a topography, in this case a convex topography, of a finger receiving surface 51 of the fingerprint sensor 5. The fingerprint sensor 5 comprises a plurality of electrically conductive sensing structures, here in the form of metal plates 41 arranged in a uniform array configuration in a sensing plane—the above-mentioned sensing surface 39—for capacitively sensing a fingerprint of a finger 53 placed on the finger receiving surface 51 of the fingerprint sensor 5.

The plurality of electrically conductive sensing structures 41 includes a first set 41a, a second set 41b, and a third set 41c of sensing structures. The first set 41a of sensing structures is arranged to be covered by a thickness of the dielectric material 25 within a first thickness range d₁-d₂, the second set 41b of sensing structures is arranged to be covered by thickness of the dielectric material 25 within a second thickness range d₃-d₄, only including greater thicknesses than the first thickness range d₁-d₂, and the third set 41c of sensing structures is arranged to be covered by thickness of the dielectric material 25 within a third thickness range d₂-d₃, between the first thickness range and the second thickness range.

The capacitive coupling between a sensing structure 41 of the fingerprint sensor 5 and a finger 53 placed on the finger receiving surface 51 is a measure of the capacitance of the capacitor formed by the sensing structure 41, the finger 53, and the dielectric material 25 between the sensing structure 41 and the finger surface. In the configuration in FIG. 6, the maximum capacitance (resulting from a ridge of the finger pattern in good contact with the finger receiving surface 51) can be considered to be proportional to the surface area of the sensing structure 41 and inversely proportional to the distance between the sensing structure and the finger surface.

As is schematically indicated in FIG. 6, the fingerprint sensor 23 further comprises a charge-modification arrangement 57 and measurement circuitry 58 coupled to the sensing structures 41 for providing measurement signals Sₘ indicative of the capacitive coupling between the sensing structures 41 and the finger 53.

In FIG. 6, the charge-modification arrangement 57 is arranged to provide three different charge modifications, as is schematically represented by the different blocks 57a-c in FIG. 6. It should be appreciated that this is only an illustration to aid the understanding of this embodiment, and that the charge-modification arrangement does not necessarily have different physical configurations in different parts thereof.

The different charge modifications 57a-c provided by the charge-modification arrangement 57 can be permanent, or the charge-modification arrangement 57 can be controllable to change charge modification for all of the sensing structures 41, or for various sets of the sensing structures. This optional controllability of the charge-modification arrangement 57 is schematically indicated by the dashed arrow 59 in FIG. 6.

Accordingly, the measurement circuitry 58 may provide a first set of measurement signals from a first set 41a of sensing structures being subjected to a first charge modification indicated by 57a, a second set of measurement signals from a second set 41b of sensing structures being subjected to a second charge modification indicated by 57b, and a third set of measurement signals from a third set 41c of sensing structures being subjected to a third charge modification indicated by 57c to allow formation of a fingerprint representation Sₘ comprising the first set of measurement signals, the second set of measurement signals, and the third set of measurement signals.

In FIG. 6, only three different charge modifications are indicated. It should be understood that this is mainly in the interest of ease of illustration and explanation. The charge-modification arrangement 57 may advantageously be configured to achieve a larger number of charge modifications. In particular, it may be advantageous to provide a substantially continuous gradation in charge modification across the length and/or width of the fingerprint sensor. For instance, each row or column of sensing structures 41 may be provided with a different charge modification, resulting in a “smooth” compensation of sensitivity variations caused by the varying thickness of the dielectric material 25 over the sensing surface 29.

The fingerprint sensor 5 may be included in a fingerprint sensing system, further comprising a fingerprint sensor controller that is coupled to the fingerprint sensor 5 for controlling operation of the fingerprint sensor 5. The fingerprint sensor controller is not explicitly shown in the drawings, but as will be clear to a person of ordinary skill in the art, the fingerprint sensor controller may be included in an electronic device, such as the mobile phone 1 in FIG. 1. The above-mentioned fingerprint sensing system may thus partly comprise circuitry included in the electronic device. According to one embodiment, the fingerprint sensor controller may be included in a fingerprint sensor module that is integrated in the electronic device (mobile phone 1), and according to another embodiment, the functionality of the fingerprint sensor controller may at least partly be realized by the host controller of the electronic device.

In embodiments, the fingerprint sensor controller may be configured to control, by means of control signals 59, the charge-modification arrangement 57 of the fingerprint sensor 5 to provide an initial charge modification distribution among the sensing structures 41. Based on measurement signals acquired using the initial charge modification distribution, the fingerprint sensor controller may determine an updated charge modification distribution among the sensing structures 41, and control, by means of the control signal 59, the charge-modification arrangement 57 to provide the updated charge modification distribution.

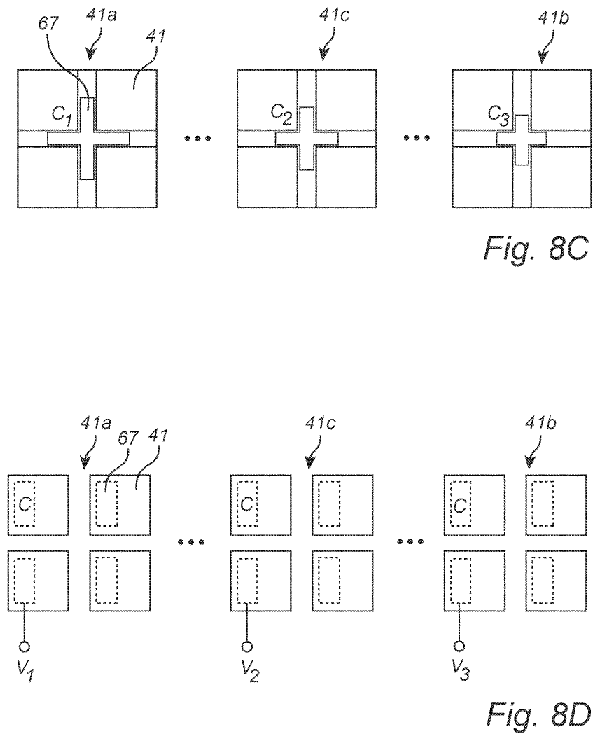

FIG. 7 schematically shows a first example configuration of the charge-modification arrangement 57 and the measurement circuitry 58 in the fingerprint sensor in FIG. 6. Referring to FIG. 7, the measurement circuitry 58 comprises amplifier circuitry 63 and analog-to-digital converter (ADC) circuitry 65. As is schematically indicated in FIG. 7, the amplifier circuitry 63 receives input from one or several sensing structures 41, and provides an amplified analog signal to the ADC circuitry 65. The ADC circuitry 65 outputs digital measurement signals Sₘ. The input from a sensing structure 41 is related to the charge (or change of the charge) carried by that sensing structure 41. The charge (or change of the charge) carried by the sensing structure 41 during a measurement operation, in turn, depends on the capacitive coupling between that sensing structure 41 and the finger 53. In addition to the difference in distance to the surface of the finger 53 due to the fingerprint topography, the capacitive coupling is influenced by the thickness of dielectric material 25 covering the sensing structure 41. To compensate for this common mode influence on the capacitive coupling, the charge-modification arrangement 57 is configured to provide different charge modification for different sensing structures 41.

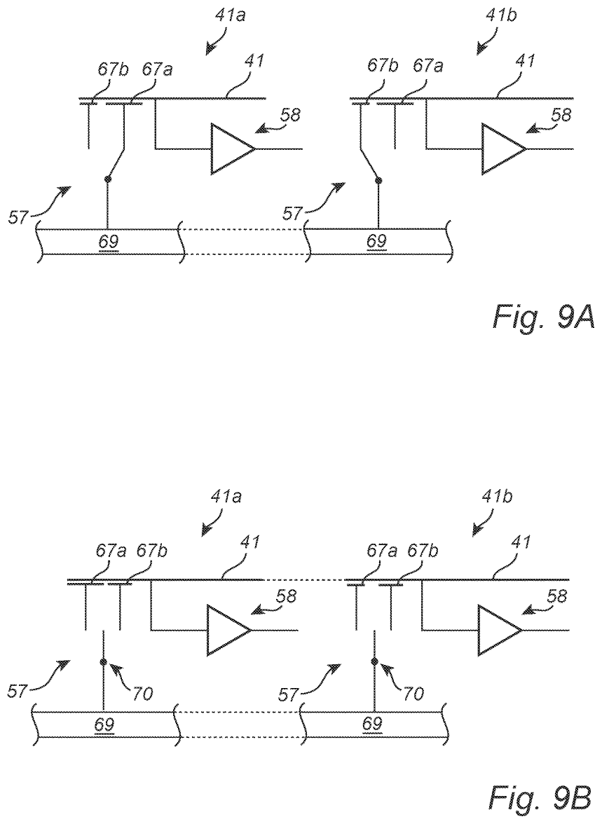

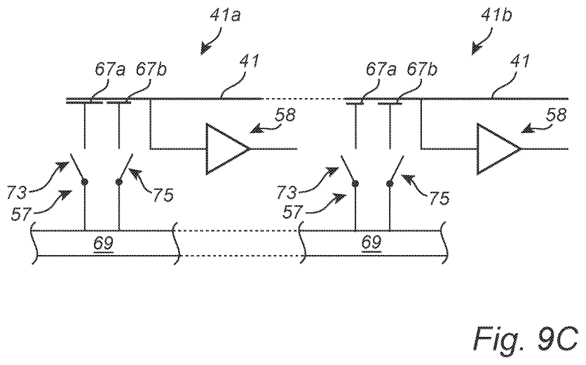

With continued reference to FIG. 7, the charge-modification arrangement 57 comprises a plurality of charge-modification structures 67 and charge-modification circuitry 69 coupled to each charge-modification structure 67. For simplicity of illustration, only one charge-modification structure 67 is indicated in the schematic illustration in FIG. 7. Various different configurations of the charge-modification arrangement 57 will be described further below with reference to FIGS. 8A-D, FIGS. 9A-B, and FIG. 10.

As is indicated in FIG. 7, its charge-modification structure 67 is arranged in relation to its associated sensing structure 41 to form a capacitor, having a capacitance C, including the sensing structure 41, the charge-modification structure 67, and a dielectric between the sensing structure 41 and the charge-modification structure 67. The charge-modification circuitry 69 is coupled to the charge-modification structure 67 (to all the charge-modification structures comprised in the charge-modification arrangement 57) and controllable to provide voltage signals V to the charge-modification structures 67. The charge-modification circuitry 69 may comprise at least one controllable voltage source, such as one or several DACs (digital-to-analog converters). There may be one controllable voltage source per set 41a-c of sensing structures 41, or there may be fewer voltage sources each having several individually controllable outputs. Depending on the desired charge modification distribution, simpler solutions may also be sufficient. For instance, a voltage source with two outputs with different voltages can be combined with a string of resistors (at least one resistor) to form intermediate voltages (at least one). Using a string of resistors, a substantially continuous voltage distribution among the charge-modification structures can be achieved, if desired.

The product of the capacitance C and the voltage V determines the modification (subtraction or addition) of the charge carried by the sensing structure 41. To control the charge modification, the capacitance C, or the voltage V, or both the capacitance C and the voltage V may be controlled, as is indicated by the control signal 59.

Although it is indicated in FIG. 7 that one amplifier circuit is connected to a single sensing structure 41, it should be noted that this is not necessarily the case, and that, for example, one amplifier circuit may be connected (selectively connectable) to a plurality of sensing structures 41.

FIGS. 8A-D schematically illustrate different example configurations of the charge-modification arrangement 57 in the fingerprint sensor in FIG. 6. In particular, FIGS. 8A-D show different arrangements of the charge-modification structures 67 in relation to the sensing structures 41 that are charge-modified by the charge-modification structures 67.

In each of FIGS. 8A-D, three groups of four sensing structures are shown. From left to right, the groups of sensing structures 41 are from the first set 41a in FIG. 6, the third set 41c in FIG. 6, and the second set 41b in FIG. 6, respectively.

It should again be pointed out that there may advantageously be considerably more than three sets of sensing structures with different charge modifications in the fingerprint sensor, and that the references herein to first, second, and third sets of sensing structures are mainly intended to simplify the description.

In FIG. 8A, the charge-modification structures 67 are electrically conductive structures arranged underneath the sensing plane, as seen from the finger receiving surface of the fingerprint sensor. As can be seen in FIG. 8A, there is one charge-modification structure 67 for each sensing structure 41. Each charge-modification structure forms a capacitor together with its associated sensing structure 41. Since the areas of overlap between the sensing structures and their associated charge-modification structures are different for the different sets 41a-c of sensing structures, the capacitances C₁-C₃ are different for the different sets 41a-c. In the example configuration of FIG. 8A, the capacitance C₁ for the peripheral first set 41a of sensing structures is greater than the capacitance C₃ for the centrally located second set 41b of sensing structures, and greater than the capacitance C₂ for the intermediate set 41c. Hereby, more charge can be subtracted from the peripheral sensing structures than from the centrally located sensing structures, if the same voltage signal is provided to all charge-modification structures 67. Hereby, the charge baseline can be evened out for a fingerprint sensor 5 with a convex finger receiving surface, as illustrated in FIG. 6. If charge modification is instead carried out by adding charge, the size relations between the charge-modification structures for the different sets 41a-c of sensing structures may be opposite that shown in FIG. 8A.

As is schematically indicated in FIG. 8B, a charge-modification structure 67 may be common to a group of sensing structures 41.

In FIG. 8C, a charge-modification structure 67 is also common to a group of sensing structures 41. The configuration in FIG. 8C differs from that in FIG. 8B in that the charge-modification structures 67 are arranged in the same plane as the sensing structures 41.

In the configuration of FIG. 8D, the areas of overlap between the sensing structures 41 and their associated charge-modification structures 67 are the same for the different sets 41a-c of sensing structures, which means that the capacitances C are the same for the different sets 41a-c (assuming that the thickness of the dielectric between the sensing structures 41 and the associated charge-modification structures 67 is the same for the different sets 41a-c of sensing structures. In the example configuration of FIG. 8D, the charge-modification circuitry (not shown in FIG. 8D) is controlled to provide different voltage signals V₁-V₃ to the charge-modification structures associated with sensing structures in the different sets 41a-c of sensing structures. In the example configuration of FIG. 8D, the voltage V₁ for the peripheral first set 41a of sensing structures may be greater than the voltage V₃ for the centrally located second set 41b of sensing structures, and greater than the voltage V₂ for the intermediate set 41c. Hereby, more charge can be subtracted from (or added to) the peripheral sensing structures than from the centrally located sensing structures.

It should again be noted that there may advantageously be a considerably larger number of different voltages across the fingerprint sensor, to provide for more precise charge modification, that is better adapted to the profile of the finger receiving surface.

FIGS. 9A-C schematically illustrate additional example configurations of the charge-modification arrangement 57 in the fingerprint sensor 5 in FIG. 6. In FIGS. 9A-C a schematic cross-section of the fingerprint sensor 5 is shown for a sensing structure in the first set 41a of sensing structures and a sensing structure in the second set 41b of sensing structures (refer to FIG. 6). As can be seen in FIGS. 9A-C, these example configurations of the charge-modification arrangement 57 comprises two charge-modification structures 67a-b for each sensing structure 41.

Turning first to FIG. 9A, the first charge-modification structure 67a has a relatively large surface area, and is the same for each sensing structure 41, in the first set 41a and the second set 41b (typically across the entire fingerprint sensor 5). The second charge-modification structure 67b has a relatively small surface area, and is the same for each sensing structure 41, in the first set 41a and the second set 41b (typically across the entire fingerprint sensor 5). As is schematically indicated in FIG. 9A, the first, relatively large charge-modification structure 67a is connected to the charge-modification circuitry 69 for the sensing structures 41 in the first set 41a of sensing structures, and the second, relatively small charge-modification structure 67b is connected to the charge-modification circuitry 69 for the sensing structures 41 in the second set 41 of sensing structures. The connection between the charge-modification structures and the charge-modification circuitry may be controllable or hard-wired. The charge-modification arrangement configuration in FIG. 9A allows simplified circuit design, and may provide some tunability of the fingerprint sensor 5 for different finger receiving surface topographies (at least in embodiments where the above-mentioned connection is controllable).

Referring now to FIG. 9B, the charge-modification arrangement 57 configuration schematically shown therein differs from that in FIG. 9A in that the first charge-modification structure 67a for each sensing structure 41 has a surface area that depends on the location of the sensing structure 41 in the fingerprint sensor 5. In the example configuration of FIG. 9B, the first charge-modification structure 67a has a larger surface area for the sensing structures in the first set 41a of sensing structure than for the sensing structures in the second set 41b of sensing structures. The second charge-modification structure 67b for each sensing structure 41, on the other hand, has the same surface area for each sensing structure 41. As is indicated in FIG. 9B, the charge-modification arrangement 57 additionally comprises a controllable switch 70 for each sensing element 41, allowing selection of which charge-modification structure (if any) to use for the sensing structure 41. With the charge-modification arrangement configuration in FIG. 9B, the same fingerprint sensor IC can be optimized for a flat finger receiving surface, and for a curved finger receiving surface. Furthermore, for instance, the setting with the same charge-modification structure surface size for each sensing structure 41 can be used for production test and calibration etc, and the other setting can be used to acquire a fingerprint representation.

FIG. 9C schematically illustrates a further example configuration of the 5 charge-modification arrangement 57, enabling improved adaptability to different finger receiving surface profiles and/or variations in production.

The configuration of the charge-modification arrangement 57 in FIG. 9C differs from that described above with reference to FIG. 9B in that there is a first switch 73 and a second switch 75 for each sensing structure 41. By selectively activating the switches 73, 75, and optionally also adapting the voltage supplied to the size-varying charge-modification structure 67a and the charge-modification structure 67b of uniform size, respectively, the charge modification can be adapted to all finger receiving surface profiles that can be expressed as, or approximated by, a second-degree polynomial. This greatly increases the adaptability of the fingerprint sensor to different products with different requirements in the surface profile of the finger receiving surface.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A fingerprint sensor comprising:
a plurality of sensing structures arranged in a sensing plane for capacitively sensing a fingerprint of a finger placed on a finger receiving surface of the fingerprint sensor;
a charge-modification arrangement including:
a plurality of charge-modification structures arranged in relation to the plurality of sensing structures to form a plurality of capacitors, each including a sensing structure in the plurality of sensing structures, a charge-modification structure in the plurality of charge-modification structures, and a dielectric between the sensing structure and the charge-modification structure; and
charge-modification circuitry coupled to each charge-modification structure in the plurality of charge-modification structures, and controllable to provide voltage signals to the plurality of charge-modification structures; and
measurement circuitry coupled to the plurality of sensing structures for providing measurement signals indicative of a capacitive coupling between each sensing structure in the plurality of sensing structures and the finger,
wherein the charge-modification arrangement is configured to provide different charge modification for different sensing structures in the plurality of sensing structures.

2. The fingerprint sensor according to claim 1, wherein each charge-modification structure in the plurality of charge-modification structures is an electrically conductive structure arranged underneath the sensing plane, as seen from the finger receiving surface.

3. The fingerprint sensor according to claim 1, wherein:
each sensing structure in the plurality of sensing structures is a metal plate; and
each charge-modification structure in the plurality of charge-modification structures is a metal plate.

4. The fingerprint sensor according to claim 1, wherein each charge-modification structure in the plurality of charge-modification structures forms one of the capacitors in the plurality of capacitors, together with its associated sensing structure.

5. The fingerprint sensor according to claim 1, wherein the plurality of capacitors comprises:
a first set of capacitors with a first capacitance; and
a second set of capacitors with a second capacitance, different from the first capacitance.

6. The fingerprint sensor according to claim 5, wherein:
each capacitor in the first set of capacitors exhibits a first area of overlap between the sensing structure and the charge-modification structure comprised in the capacitor; and
each capacitor in the second set of capacitors exhibits a second area of overlap, different from the first area, between the sensing structure and the charge-modification structure comprised in the capacitor.

7. The fingerprint sensor according to claim 1, wherein the charge-modification circuitry is configured to provide different voltage signals to different charge-modification structures.

8. The fingerprint sensor according to claim 7, wherein the charge-modification circuitry comprises a controllable voltage source.

9. The fingerprint sensor according to claim 8, wherein the charge-modification circuitry comprises:
a first output coupled to a first set of the charge-modification structures to provide a first voltage signal to each charge-modification structure in the first set of charge-modification structures; and
a second output coupled to a second set of the charge-modification structures to provide a second voltage signal to each charge-modification structure in the second set of charge-modification structures.

10. The fingerprint sensor according to claim 9, wherein the charge-modification circuitry comprises:
a third output coupled to a third set of the charge-modification structures to provide a third voltage signal to each charge-modification structure in the third set of charge-modification structures;
a first resistor coupled between the first output and the third output; and
a second resistor coupled between the second output and the third output.

11. The fingerprint sensor according to claim 9, wherein the charge-modification circuitry comprises:
a first individually controllable voltage source coupled to each charge-modification structure in the first set of charge-modification structures; and
a second individually controllable voltage source coupled to each charge-modification structure in the second set of charge-modification structures.

12. The fingerprint sensor according to claim 1, wherein the fingerprint sensor comprises dielectric material covering the sensing plane of the fingerprint sensor, the dielectric material having a non-uniform thickness profile defining a topography of the finger receiving surface of the fingerprint sensor.

13. The fingerprint sensor according to claim 12, wherein the charge-modification arrangement is configured to provide:
a first charge modification for sensing structures covered by a thickness of the dielectric material within a first thickness range; and
a second charge modification for sensing structures covered by a thickness of the dielectric material within a second thickness range, only including greater thicknesses than the first thickness range.

14. An electronic device comprising:
a device housing with a convex portion having an opening; and
the fingerprint sensor according to claim 12 arranged in the opening of the curved portion of the device housing.

15. A method of acquiring a fingerprint representation using a fingerprint sensor with a finger receiving surface to be touched by a finger, the fingerprint sensor comprising a plurality of sensing structures arranged in a sensing plane; a charge-modification arrangement including a plurality of charge-modification structures arranged in relation to the plurality of sensing structures to form a plurality of capacitors, each including a sensing structure in the plurality of sensing structures, a charge-modification structure in the plurality of charge-modification structures, and a dielectric between the sensing structure and the charge-modification structure;
and charge-modification circuitry coupled to each charge-modification structure in the plurality of charge-modification structures; and measurement circuitry coupled to the plurality of sensing structures for providing measurement signals indicative of a capacitive coupling between each sensing structure in the plurality of sensing structures and the finger; and dielectric material covering the sensing plane, the dielectric material having a non-uniform thickness profile defining a topography of the finger receiving surface of the fingerprint sensor,
the method comprising the steps of:
acquiring a first set of measurement signals from a first set of sensing structures in the plurality of sensing structures, covered by a thickness of the dielectric material within a first thickness range, while providing by the charge-modification arrangement a first charge modification to the first set of sensing structures; and
acquiring a second set of measurement signals from a second set of sensing structures in the plurality of sensing structures, covered by a thickness of the dielectric material within a second thickness range, only including greater thicknesses than the first thickness range, while providing by the charge-modification arrangement a second charge modification to the second set of sensing structures.
